(19) United States
(12) Patent Application Publication
(10) Pub. No.: US 2015/0068634 A1
(43) Pub. Date: Mar. 12, 2015

(54) RESIN HOSE AND METHOD FOR MANUFACTURING THE SAME

(71) Applicant: TOKAI RUBBER INDUSTRIES, LTD., Komaki-shi (JP)

(72) Inventors: Kazutaka KATAYAMA, Kasugai-shi (JP); Tomoyuki FUKUYASU, Nisshin-shi (JP); Makoto SHIMOJO, Komaki-shi (JP); Takaaki INOUE, Nagoya-shi (JP); Takahiro NISHIYAMA, Inazawa-shi (JP)

(21) Appl. No.: 14/333,028

(22) Filed: Jul. 16, 2014

(30) Foreign Application Priority Data
Sep. 10, 2013 (JP) 2013-187230

(51) Int. Cl. F16L 11/12; B29D 23/00; F16L 11/06

(52) U.S. Cl. CPC F16L 11/121; F16L 11/06; B29D 23/001; B29K 2023/065
USPC 138/118; 264/167

(57) ABSTRACT

The invention is to provide a resin hose capable of sufficiently ensuring the flow rate of fluid flowing through the resin hose while ensuring flexibility of wiring. The resin hose includes a round portion having a round flow-passage; and a flat portion that includes a flat flow-passage and has a flow-passage cross-section area equal to or larger than a flow-passage cross-section area of a minimum inner diameter portion in the round portion, a short width of the flat flow-passage being smaller than an inner diameter of the minimum inner diameter portion and a long width of the flat flow-passage being larger than the inner diameter of the minimum inner diameter portion.

### INCORPORATION BY REFERENCE

This application is based upon and claims the benefit of priority of the Japanese Patent Application No. 2013-187230, filed on Sep. 10, 2013, the entire contents of which are incorporated herein by reference.

### BACKGROUND OF THE INVENTION

1. Field of the Invention

The present invention relates to a resin hose and a method for manufacturing the same.

2. Description of the Related Art

In an automobile, fuel fed from a fuel feeding port passes through a filler hose to be stored in a fuel tank. The filler hose is required to smoothly flow the fuel. Thus, for example, JP 2003-182385 A discloses a filler hose in which fuel is straightened and smoothly flows by a portion having a reduced cross-section area of a flow passage in a radial direction. In addition, JP 2010-137591 A discloses a filler hose in which a belt-shaped guide surface is formed.

Further, a resin hose having a non-circular cross-section shape is each disclosed in JP 2001-165383 A, JP 2004-351658 A, and JP 10-257634 A. In addition, a resin composite hose having a non-circular cross-section shape is disclosed in JP

### SUMMARY OF THE INVENTION

However, as in JP 2003-182385 A, when the cross-section area in the radial direction is reduced in the hose through which liquid such as fuel flows, since the flow rate of fluid flowing through the reduced cross-section area portion is small compared to other portions, the flow rate of fluid flowing through the entire hose becomes smaller.

In addition, particularly in an automobile, it is not easy to wire a fuel hose of a circular cross-section shape concerning placement of other parts. Therefore, the cross-section shape of the fuel hose is required to be, for example, a flat shape according to the portion to be placed. That is, it is required to sufficiently ensure the flow rate of fluid flowing through the resin hose while ensuring flexibility of wiring.

Further, in the case of molding a resin hose into a flat shape, for example, there are a method of molding a material of a circular cross-section shape by press forming, a method of forming an inner peripheral surface shape of a mold for molding a molten resin into a flat shape in advance, and a method of forming a shape of a mandrel for inserting a resin hose into a flat shape. However, even when any of these methods is used, there is a limit to a flattening ratio to be obtained. The flexibility of wiring is improved by obtaining a shape having a higher flattening ratio. Therefore, it is required to obtain a resin hose of a shape having a high flattening ratio.

The invention is achieved in consideration of the above circumstances, and a first object is to sufficiently ensure the flow rate of fluid flowing through a resin hose while ensuring flexibility of wiring. A second object is to manufacture a resin hose of a shape having a high flattening ratio.

(Resin Hose)

The resin hose according to an aspect of the invention comprises: a round portion having a round flow-passage; and a flat portion that includes a flat flow-passage and has a flow-passage cross-section area equal to or larger than a flow-passage cross-section area of a minimum inner diameter portion in the round portion, a short width of the flat flow-passage being smaller than an inner diameter of the minimum inner diameter portion and a long width of the flat flow-passage being larger than the inner diameter of the minimum inner diameter portion.

When the resin hose has the flat portion, flexibility of wiring of the resin hose is improved. Here, even though the resin hose has the flat portion, since the flow-passage cross-section area of the flat portion is equal to or larger than the flow-passage cross-section area of the minimum inner diameter portion in the round portion, it is possible to ensure that the flow rate of fluid flowing through the flat portion is equal to or more than the flow rate in the minimum round portion. As a result, the flow rate of fluid flowing through the resin hose totally increases.

Preferably, the flat portion may be manufactured using: a resin melting and molding process of molding an intermediate flat portion of an intermediate molded body, the intermediate flat portion having a flow-passage cross-section area larger than the flow-passage cross-section area of the flat portion, by introducing a molten resin into a metal mold having a flat-shaped inner peripheral surface and then solidifying the molten resin; and a press forming process of forming the flat portion by press forming the intermediate flat portion of the intermediate molded body to further reduce a short width of the intermediate flat portion in the intermediate molded body.

Here, the process of introducing the molten resin into the metal mold having the flat-shaped inner peripheral surface and subsequently solidifying the molten resin in the resin melting and molding process is called “resin melting and molding”. That is, in the resin melting and molding process, the intermediate flat portion of the intermediate molded body is formed by the resin melting and molding, and then the flat portion as a final shape is formed by press forming the intermediate flat portion of the intermediate molded body. Accordingly, the flat portion is not molded by a single molding process but is formed by two times of forming processes. As a result, it is possible to form the resin hose of the shape having the high flattening ratio.

If the flat portion is formed by press forming the cylindrical-shaped intermediate molded body, positioning of the cylindrical-shaped intermediate molded body is not easy, and the phase of the flat portion is likely to be deviated from a desired phase. In contrast, according to the above process, since the press forming is performed on the intermediate flat portion of the previously molded intermediate molded body, a flat direction easily coincides with the short width direction of the intermediate flat portion. Accordingly, the phase of the finally shaped flat portion can easily become the desired phase.

In addition, if the flat portion having a small short-width is molded only by the resin melting and molding, the flat-shaped inner peripheral surface of the metal mold is required to be formed into a shape having the small short-width as in the flat portion. Then, since the size of a nozzle for injecting the molten resin into the metal mold is restricted by the size of the inner peripheral surface of the metal mold, the diameter of the nozzle has to become small. When the diameter of the nozzle becomes small, the pressure of the molten resin injected from the nozzle is raised and productivity decreases. In contrast, according to the resin melting and molding process of the above aspect of the invention, the short width of the intermediate flat portion of the intermediate molded body is larger than the short width of the finally shaped flat portion. Accordingly, it is possible to improve the productivity.

In addition, preferably, the short width of the flat flow-passage of the intermediate flat portion in the intermediate molded body is equal to or larger than the inner diameter of the round portion, and the long width of the flat flow-passage of the intermediate flat portion in the intermediate molded body is larger than the inner diameter of the round portion.

Therefore, it is possible to sufficiently increase the size of the nozzle for injecting the molten resin into the metal mold in the resin melting and molding process. As a result, it is possible to reduce the pressure of the molten resin injected from the nozzle into the metal mold. Therefore, it is possible to provide higher productivity.

In addition, preferably, the flat portion is formed by press forming the intermediate flat portion in a state where a mandrel having a diameter equal to or smaller than the short width of the flat flow-passage in the flat portion is inserted into the intermediate molded body, in the press forming process.

Since the press forming is performed in the state where the mandrel is inserted into the intermediate molded body, a deformation amount due to the press forming is regulated by the mandrel. Accordingly, it is possible to easily form the flat portion of the desired shape. Moreover, the diameter of the mandrel is equal to or shorter than the short width of the flat flow-passage in the flat portion. That is, in the case of performing the press forming, the gap remains formed in the direction of the long width of the flat portion. Even though the gap exists, since the intermediate flat portion of the intermediate molded body is previously molded, it is possible to form the desired flat portion. Further, it is possible to easily insert the mandrel into the intermediate molded body by forming the diameter of the mandrel to be equal to or shorter than the short width of the flat flow-passage in the flat portion.

In addition, preferably, the resin hose comprises a straight pipe portion and a bent portion formed by at least a part of the intermediate flat portion, the intermediate molded body is molded into a straight pipe shape, and the flat portion is formed in the resin hose and the bent portion is also formed such that both sides in the direction of the short width of the intermediate flat portion become an outer bent side and an inner bent side of the bent portion, by press forming on the intermediate molded body having the straight pipe shape in the press forming process.

When the bent portion is formed by the press forming, wrinkles are less likely to occur in the bent portion by configuring such that at least a part of the bent portion includes the previously molded intermediate flat portion and both sides in the direction of the short width become the outer bent side and the inner bent side of the bent portion.

In addition, preferably, the minimum inner diameter portion of the round portion is disposed at both ends of the flat portion in a flow direction.

The long width of the flat portion is larger than the inner diameter of the minimum inner diameter portion of the round portion. For this reason, in the resin hose provided with the round portion having the minimum inner diameter at both ends of the flat portion, since the mandrel is formed into an undercut shape when the forming is performed by the mandrel, it is difficult to perform the forming with the mandrel. However, even in the resin hose having such a shape, it is possible to reliably perform the forming without depending on the shape of the mandrel by applying the above aspect of the invention.

(Method for Manufacturing Resin Hose)

A method for manufacturing a resin hose according to another aspect of the invention is a method for manufacturing a resin hose with a flat portion and includes: a resin melting and molding process of molding an intermediate flat portion of an intermediate molded body by introducing a molten resin into a metal mold having a flat-shaped inner peripheral surface and then solidifying the molten resin; and a press forming process of forming the flat portion having a flow-passage cross-section area smaller than a flow-passage cross-section area of the intermediate flat portion of the intermediate molded body by press forming the intermediate flat portion of the intermediate molded body to further reduce a short width of the intermediate flat portion in the intermediate molded body.

That is, in the manufacturing method according to the above aspect of the invention, the intermediate flat portion of the intermediate molded body is formed by the resin melting and molding, and then the flat portion as a final shape is formed by performing the press forming the intermediate flat portion of the intermediate molded body. Accordingly, the flat portion is not molded by a single molding process but is formed by two times of forming processes. As a result, it is possible to form the resin hose of the shape having a high flattening ratio. Moreover, according to the above aspect of the invention, the phase of the flat portion can easily become the desired phase and the productivity can be improved.

### BRIEF DESCRIPTION OF THE DRAWINGS

FIG. 1 is a configuration diagram illustrating a case where a resin hose 10 of a first embodiment is adapted to a filler pipe;

FIG. 2A is a cross-sectional view taken along line 2A-2A in FIG. 1;

FIG. 2B is a cross-sectional view taken along line 2B-2B in FIG. 1;

FIG. 2C is a cross-sectional view taken along line 2C-2C in FIG. 1;

FIG. 3 is a flowchart illustrating a method for manufacturing the resin hose 10;

FIG. 4 is a diagram illustrating a resin melting and molding process S1 in FIG. 3;

FIG. 5A is an axial cross-sectional view of an intermediate molded body 50 molded by the resin melting and molding process in FIG. 4;

FIG. 5B is a cross-sectional view taken along line 5B-5B of the intermediate molded body 50 illustrated in FIG. 5A;

FIG. 6A is a cross-sectional view taken along line 6A-6A of the intermediate molded body 50 illustrated in FIG. 5A;

FIG. 6B is a cross-sectional view taken along line 6B-6B of the intermediate molded body 50 illustrated in FIG. 5A;

FIG. 6C is a cross-sectional view taken along line 6C-6C of the intermediate molded body 50 illustrated in FIG. 5A;

FIG. 7A is a diagram illustrating an initial state of a press forming process S4 in FIG. 3;

FIG. 7B is a diagram illustrating a state where press forming is finished by metal molds 210 and 220 in FIG. 7A;

FIG. 8 is a flowchart illustrating a method for manufacturing the resin hose 10 according to a second embodiment;

FIG. 9A is a diagram illustrating an initial state of a press forming process S5 in FIG. 8; and

FIG. 9B is a diagram illustrating a state where press forming is finished by metal molds 310 and 320 in FIG. 9A.

### DETAILED DESCRIPTION OF THE PREFERRED EMBODIMENTS

### First Embodiment

### 1. Configuration of Resin Hose 10

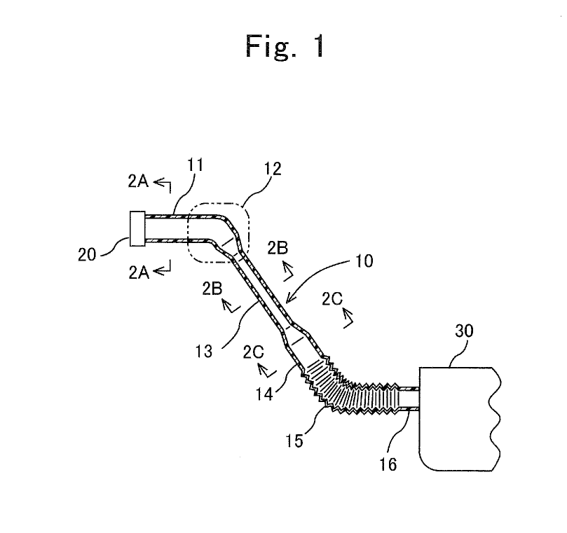

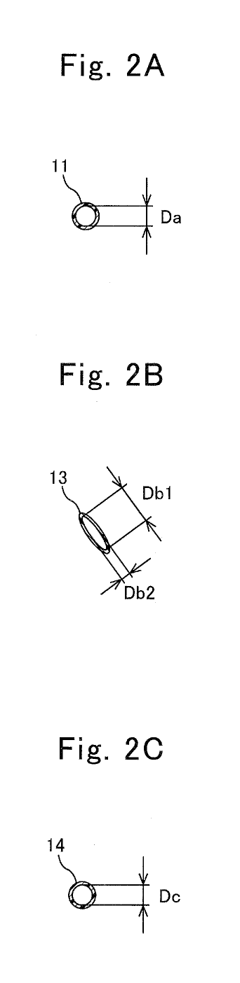

The resin hose 10 according to the first embodiment will be described with reference to FIGS. 1 and 2A to 2C. The resin hose 10 is applied as, for example, a filler hose (also referred to as a filler pipe) of an automobile. That is, a fuel feeding cap 20 is mounted to one end of the resin hose 10 and the other end of the resin hose 10 is attached to a fuel tank 30. Then, a fuel feeding gun (not illustrated) is inserted into a fuel feeding port, and fuel fed from the fuel feeding gun passes through the hose and flows into the fuel tank 30. Further, a breather pipe or the like is present but is not illustrated in FIG. 1.

The resin hose 10 is formed of one or more kinds of resin layers. As one of resin materials for forming the resin hose 10 adapted to the filler hose, for example, high density polyethylene (HDPE) having excellent fuel oil resistance is preferable.

Here, the resin hose 10 is wired between the fuel feeding port and the fuel tank 30, but other parts constituting the automobile are present in such a region. For this reason, as illustrated in FIG. 1, the resin hose 10 is wired such that the resin hose 10 avoids other parts. The resin hose 10 includes a one-end round portion 11, a bent portion 12, a flat straight-pipe portion 13, an intermediate round portion 14, a bellows-like bent portion 15, and an other-end round portion 16. Here, the round portions 11, 14, and 16 and the flat straight-pipe portion 13 correspond to a straight pipe portion of the invention.

The fuel feeding cap 20 is mounted to the one-end round portion 11 of the resin hose 10. The other-end round portion 16 of the resin hose 10 is attached to the fuel tank 30. As illustrated in FIGS. 2A and 2C, the one-end round portion 11 and the intermediate round portion 14 have a round flow-passage (tubular with round cross-section in a radial direction). In addition, the other-end round portion 16 has similarly a round flow-passage (not illustrated).

As illustrated in FIGS. 2A and 2C, inner diameters in minimum inner diameter portions of the round portions 11 and 14 in the resin hose 10 are defined by Da and Dc, respectively. In addition, although not illustrated, an inner diameter in a minimum inner diameter portion of the other-end round portion 16 will be described as Dc. Since end portions of the round portions 11 and 16 may be enlarged in diameter, the minimum inner diameter portions are defined herein in order to specify the minimum inner diameter portions in the round portions 11, 14, and 16 including the enlarged diameter portion.

As illustrated in FIG. 2B, the flat straight-pipe portion 13 has a flat flow-passage. In the first embodiment, the flat straight-pipe portion 13 is formed into an elliptical shape, but may be formed into a flat shape such as an oval shape or a rectangular shape. A long width (corresponding to a long diameter of the ellipse) of the flat flow-passage of the flat straight-pipe portion 13 is Db1, a short width (corresponding to a short diameter of the ellipse) of the flat flow-passage is Db2. The vicinity of the flat straight-pipe portion 13 passes between a tire and a body member, for example. That is, the flat straight-pipe portion 13 of the resin hose 10 is formed into the flat shape so as to pass through a narrow gap portion.

The bent portion 12 of the resin hose 10 is formed into a non-bellows-like tubular shape, and at least a part of the flat straight-pipe portion 13 has a flat tubular shape at the bent portion 12. Accordingly, the bent portion 12 has a shape with no flexibility in shape deformation. On the other hand, the bellows-like bent portion 15 of the resin hose 10 is formed into a bellows-like tubular shape. Therefore, the bellows-like bent portion 15 has a shape with the flexibility in shape deformation.

Here, the relation between the inner diameters Da and Dc of the minimum inner diameter portion of the round flow-passage in the round portions 11, 14, and 16 and the long width Db1 and the short width Db2 of the flat flow-passage of the flat straight-pipe portion 13 is indicated in Formula (1). That is, the long width Db1 of the flat flow-passage is larger than the inner diameters Da and Dc of the minimum inner diameter portion in the round portions 11, 14, and 16, and the short width Db2 of the flat flow-passage is smaller than the inner diameters Da and Dc of the minimum inner diameter portion.

[Formula 1]

Db1>Da=Dc>Db2 (1)

In addition, assumed that a flow-passage cross-section area of the minimum inner diameter portion in the round portion 11 is Sa, a flat flow-passage cross-section area of the flat straight-pipe portion 13 is Sb, and a flow-passage cross-section area of the minimum inner diameter portion in the round portions 14 and 16 is Sc, the relation of Formula (2) is satisfied. That is, the flow-passage cross-section area Sb of the flat straight-pipe portion 13 is equal to or larger than the flow-passage cross-section areas Sa and Sc of the minimum inner diameter portion in the round portions 11, 14, and 16.

[Formula 2]

Sb≧Sa=Sc (2)

As described above, since the resin hose 10 has the flat straight-pipe portion 13, flexibility of wiring of the resin hose 10 is improved. In addition, since the resin hose 10 also has the bellows-like bent portion 15, the flexibility of wiring of the resin hose 10 is improved.

Here, the flow-passage cross-section area Sb of the flat straight-pipe portion 13 is larger than the flow-passage cross-section areas Sa and Sc of the minimum inner diameter portion in the round portions 11, 14, and 16. For this reason, it is possible to ensure that the flow rate of fluid flowing through the flat straight-pipe portion 13 is equal to or more than the flow rate in the minimum round portion of the round portions 11, 14, and 16. As a result, the flow rate of the fluid flowing through the resin hose 10 totally increases.

### 2. Method for Manufacturing Resin Hose 10

(2.1. Overview of all Processes in Method for Manufacturing Resin Hose 10)

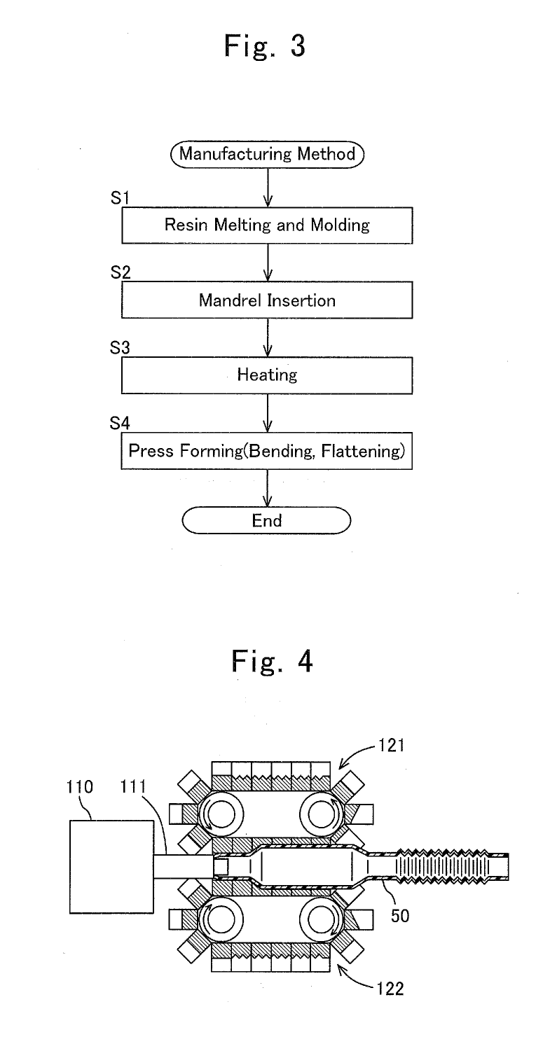

Next, a method for manufacturing the above-described resin hose 10 will be described with reference to FIGS. 3 to 7B. Here, the flat straight-pipe portion 13 is formed into the flat shape by resin melting and molding as a first process, and then a flattening ratio thereof is improved by press forming as a second process.

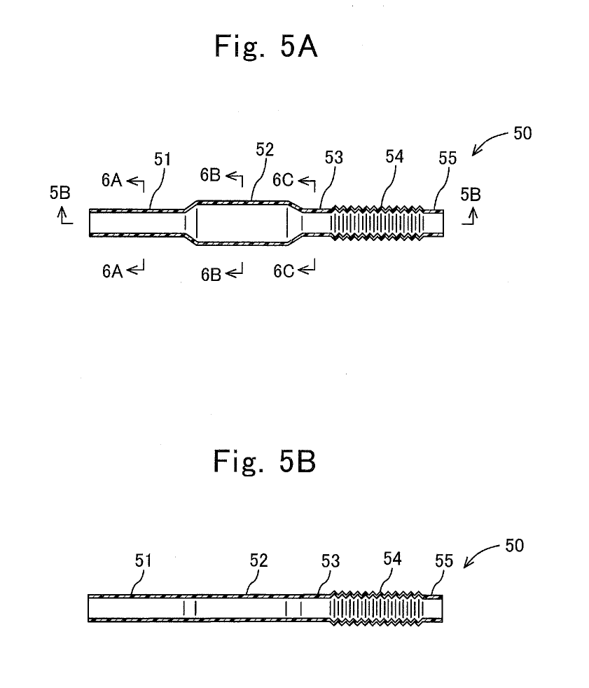

First, the overview of the method for manufacturing the resin hose 10 will be described with reference to FIG. 3. As illustrated in FIG. 3, a worker manufactures a straight pipe-shaped intermediate molded body 50 using the resin melting and molding (S1: resin melting and molding process). At this time, a portion 52 (illustrated in FIGS. 5A and 5B) corresponding to the flat portion of the flat straight-pipe portion 13 and the bent portion 12 is molded into the flat shape in advance as the first process. Here, the resin melting and molding includes, for example, extrusion blow molding, extrusion molding, injection blow molding, or injection molding. Further, the extrusion blow molding, which will be described below, is suitable for the molding of the resin hose 10.

Subsequently, the worker inserts a mandrel 60, which has a circular cross-section shape and is formed by, for example, a flexible resin material or metal spring, into the intermediate molded body 50 (S2). That is, the mandrel 60 is bendable but is formed so as to maintain the cross-section shape in the radial direction. The outer diameter of the mandrel 60 is sized to coincide with the short width Db2 of the flat straight-pipe portion 13 of the resin hose 10. Further, the mandrel 60 may have an angular cross-section shape such as a rectangular cross-section shape other than the circular cross-section shape. For example, a width between opposite surfaces in the mandrel 60 having the rectangular cross-section is sized to coincide with the short width Db2 of the flat straight-pipe portion 13.

Subsequently, after the intermediate molded body 50 is heated to be softened (S3), the flat straight-pipe portion 13 and the bent portion 12 are formed by the press forming (S4: press forming process). The flat straight-pipe portion 13 is formed by further increasing the flattening ratio of the intermediate flat portion 52 (illustrated in FIGS. 5A and 5B) of the intermediate molded body 50. In this way, the resin hose 10 illustrated in FIG. 1 is manufactured. Further, since the bellows-like bent portion 15 is bendable, a bending degree of the bellows-like bent portion is freely adjusted at the time of being attached to, for example, an automobile after the resin hose 10 is manufactured as a single body.

(2.2. Details of Resin Melting and Molding Process)

Next, details of the resin melting and molding process S1 in FIG. 3 will be described with reference to FIGS. 4 to 6C. In the resin melting and molding process according to the first embodiment, the extrusion molding is performed using an extruder 110 to mold the resin into the cylindrical shape and molding for imparting the shape is also performed using metal mold rows 121 and 122.

As illustrated in FIG. 4, the molten resin material is extruded into the cylindrical shape from a nozzle 111 of the extruder 110. A tip of the nozzle 111 is inserted between the upper metal mold row 121 and the lower metal mold row 122 which are provided to be capable of rotating, respectively. The molten resin of the cylindrical shape extruded from the nozzle 111 is injected between the upper metal mold row 121 and the lower metal mold row 122.

Simultaneously, gas pressure is applied from the inside of the nozzle 111. Accordingly, the molten resin material is pressed against the inner peripheries of the metal mold rows 121 and 122, and thus the molten resin of the cylindrical shape is molded depending on an inner peripheral surface shape of each metal mold.

Then, after the molten resin is introduced into the metal mold rows 121 and 122, the introduced resin is cooled when passing through the inside of the metal mold rows 121 and 122, and thus the molded molten resin is solidified. In this way, the intermediate molded body 50 is molded.

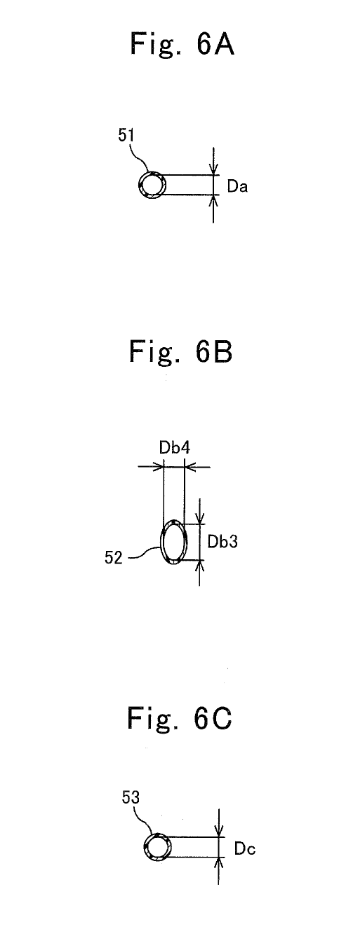

The intermediate molded body 50 has shapes illustrated in FIGS. 5A, 5B, and 6A to 6C. That is, the intermediate molded body 50 is formed into a straight pipe shape. The intermediate molded body 50 includes a round portion 51, an intermediate flat portion 52, a round portion 53, a bellows-like portion 54, and a round portion 55 from one end side (left side in FIG. 5A). Further, the inner peripheral surface of the metal mold rows 121 and 122 illustrated in FIG. 4 is shaped to be capable of being formed into an outer shape of the intermediate molded body 50.

The round portions 51, 53, and 55 of the intermediate molded body 50 have a round flow-passage, that is, a round cross-section shape in the radial direction, respectively. Inner diameters of the minimum inner diameter portions in the round portions 51, 53, and 55 are defined by Da and Dc as illustrated in FIGS. 6A and 6C. Here, the inner diameters Da and Dc of the minimum inner diameter portions in the round portions 51, 53, and 55 are equal to Da and Dc illustrated in FIGS. 2A and 2C. That is, the round portions 51, 53, and 55 correspond to a part of the one-end round portion 11 of the finally formed resin hose 10, the intermediate round portion 14, and the other-end round portion 16, respectively.

As illustrated in FIG. 6B, the intermediate flat portion 52 has a flat flow-passage, that is, a flat cross-section shape in the radial direction. In the first embodiment, the intermediate flat portion 52 of the intermediate molded body 50 is formed into an elliptical shape, but may be formed into a flat shape such as an oval shape or a rectangular shape. A long width (corresponding to a long diameter of the ellipse) of the flow-passage of the intermediate flat portion 52 is defined by Db3, a short width (corresponding to a short diameter of the ellipse) of the flat flow-passage is defined by Db4.

Here, in the intermediate molded body 50, the relation between the inner diameters Da and Dc (equal to Da and Dc in FIGS. 2A and 2C) of the round flow-passage in the round portions 51, 53, and 55 and the long width Db3 and the short width Db4 of the flow-passage in the intermediate flat portion 52 is indicated in Formula (3). That is, the long width Db3 of the flow-passage of the intermediate flat portion 52 in the intermediate molded body 50 is larger than the inner diameters Da and Dc of the minimum inner diameter portion in the round portions 51, 53, and 55, and the short width Db4 of the flat flow-passage is almost the same as the inner diameters Da and Dc of the minimum inner diameter portion in the round portions 51, 53, and 55. However, the short width Db4 may be larger than the inner diameters Da and Dc.

[Formula 3]

Db3>Da=Dc≈Db4 (3)

In addition, the relation between the long width Db3 and short width Db4 in the intermediate flat portion 52 of the intermediate molded body 50 and the long width Db1 and short width Db2 in the flat straight-pipe portion 13 of the finally formed resin hose 10 is indicated in Formula (4). That is, the flattening ratio of the intermediate flat portion 52 of the intermediate molded body 50 is smaller than the flattening ratio of the flat straight-pipe portion 13 of the finally formed resin hose 10.

[Formula 4]

Db1>Db3>Db4>Db2 (4)

In the intermediate molded body 50, assumed that a flow-passage cross-section area of the minimum inner diameter portion of the round portion 51 is Sa2, a flow-passage cross-section area of the intermediate flat portion 52 is Sb2, and a flow-passage cross-section area of the minimum inner diameter portion of the round portion 53 and 55 is Sc2, the relation of Formula (5) is derived from the relation of Formula (3). That is, the flow-passage cross-section area Sb2 of the intermediate flat portion 52 has a cross-section area larger than the flow-passage cross-section areas Sa2 and Sc2 of the minimum inner diameter portion of the round portions 51, 53, and 55.

[Formula 5]

Sb2>Sa2=Sc2 (5)

Further, as indicated in Formula (6), the flow-passage cross-section area Sb2 of the intermediate flat portion 52 of the intermediate molded body 50 is larger than the flow-passage cross-section area Sb of the flat straight-pipe portion 13 of the finally formed resin hose 10.

[Formula 6]

Sb2>Sb (6)

(2.3. Details of Press Forming Process)

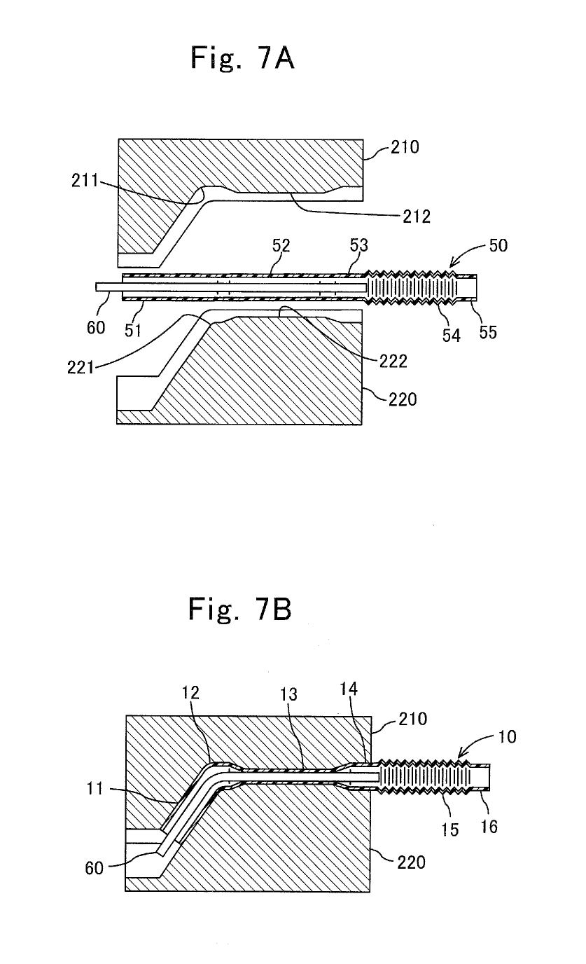

Next, details of a press forming process S4 in FIG. 3 will be described with reference to FIGS. 7A and 7B. In the press forming process, bending forming is performed on a part of the round portion 51 and a part of the intermediate flat portion 52 in the intermediate molded body 50, and thus the bent portion 12 of the resin hose 10 is formed.

In the press forming process, further, the flat straight-pipe portion 13 of the resin hose 10 is formed by increasing the flattening ratio of the intermediate flat portion 52 of the intermediate molded body 50. That is, the flat straight-pipe portion 13 of the resin hose 10 is formed by further reducing the short width Db4 of the intermediate flat portion 52 of the intermediate molded body 50 and by increasing the long width Db3.

Specifically, metal molds 210 and 220 are used in the press forming process. As illustrated in FIG. 7A, a cavity formed by the metal molds 210 and 220 includes bent forming portions 211, 221 and flat forming portions 212 and 222. The intermediate molded body 50 into which the mandrel 60 is inserted is disposed between the metal molds 210 and 220. At this time, the intermediate molded body 50 is disposed such that the intermediate flat portion 52 of the intermediate molded body 50 is located at a position of the flat forming portion 222 of one metal mold 220. That is, since the intermediate flat portion 52 is flat, when the intermediate flat portion is located at the flat forming portion 222 of the metal mold 220, phase positioning can be easy.

Then, as illustrated in FIG. 7B, the press forming is performed on the intermediate molded body 50 by moving the metal molds 210 and 220, and the resin hose 10 of the final shape is formed. Therefore, the bent portion 12 of the resin hose 10 is formed by the bent forming portions 211 and 221 of the metal molds 210 and 220. In addition, the flat straight-pipe portion 13 of the resin hose 10 is formed by the flat forming portions 212 and 222 of the metal molds 210 and 220.

### 3. Summary

The flow-passage cross-section area Sb of the flat straight-pipe portion 13 of the resin hose 10 is equal to or larger than the minimum flow-passage cross-section areas Sa and Sc of the round portions 11, 14, and 16. Accordingly, it is possible to ensure that the flow rate of fluid flowing through the flat straight-pipe portion 13 is equal to or more than the flow rate in the minimum round portion of the round portions 11, 14, and 16. As a result, the flow rate of fluid flowing through the resin hose 10 totally increases.

Here, it is assumed that the intermediate flat portion 52 of the intermediate molded body 50 is not the flat shape but a round shape having the same diameter as the minimum inner diameter portion of the round portions 11, 14, and 16. When the flat portion is formed by performing the press forming the round shape portion, the flow-passage cross-section area of the flat portion inevitably becomes smaller than the flow-passage cross-section area of the round portion. That is, when the shape before the press forming is the round shape having the same diameter as in the round portion, it is not possible to obtain a flat portion having an intended flow-passage cross-section area.

In the first embodiment, as described above, the intermediate flat portion 52 having the flow-passage cross-section area larger than that of the round portions 51, 53, and 55 is molded in the resin melting and molding, and the desired flat straight-pipe portion 13 as the final shape is formed by press forming the intermediate flat portion 52. Thus, it is possible to obtain the desired flat straight-pipe portion 13 by combining the resin melting and molding process with the press forming process. Further, since the flat straight-pipe portion 13 is not molded by a single molding process but is formed by two times of forming processes, it is possible to form the resin hose 10 of the shape having the high flattening ratio.

In addition, if the flat straight-pipe portion 13 is formed by press forming the cylindrical-shaped intermediate molded body 50, positioning of the cylindrical-shaped intermediate molded body 50 is not easy, and the phase of the flat straight-pipe portion 13 is likely to be deviated from a desired phase. In contrast, according to the first embodiment, since the press forming is performed on the intermediate flat portion 52 of the previously molded intermediate molded body 50, a flat direction easily coincides with the short width direction of the intermediate flat portion 52. That is, the phase of the finally shaped flat straight-pipe portion 13 can easily become the desired phase.

In addition, if the flat straight-pipe portion 13 having a small short-width is molded only by the resin melting and molding, the flat-shaped inner peripheral surface of the metal mold rows 121 and 122 is required to be formed into a shape having the small short-width as in the flat straight-pipe portion 13. Then, since the size of the nozzle 111 for injecting the molten resin into the metal mold rows 121 and 122 is restricted by the size of the inner peripheral surface of the metal mold rows 121 and 122, the diameter of the nozzle 111 has to become small. When the diameter of the nozzle 111 becomes small, the pressure of the molten resin injected from the nozzle 111 is raised and productivity decreases. In contrast, according to the resin melting and molding process of the first embodiment, the short width of the intermediate flat portion 52 of the intermediate molded body 50 is larger than the short width of the finally shaped flat straight-pipe portion 13. Accordingly, it is possible to improve the productivity.

Particularly, in the first embodiment, the short width Db4 of the flat flow-passage of the intermediate flat portion 52 is equal to or larger than the inner diameters Da and Dc of the round portions 11, 14, and 16, and the long width Db3 of the flat flow-passage of the intermediate flat portion 52 is larger than the inner diameters Da and Dc of the round portions 11, 14, and 16.

Therefore, it is possible to sufficiently increase the size of the nozzle 111 for injecting the molten resin into the metal mold rows 121 and 122 in the resin melting and molding process. As a result, it is possible to sufficiently reduce the pressure of the molten resin injected from the nozzle 111 into the metal mold rows 121 and 122. Therefore, it is possible to provide excellent productivity.

Further, in the press forming process, the press forming is performed on the intermediate flat portion 52 of the intermediate molded body 50 in the state where the mandrel 60 having the diameter equal to or smaller than the short width Db2 of the flat flow-passage in the flat straight-pipe portion 13 is inserted into the intermediate molded body 50, and the flat straight-pipe portion 13 is formed. Accordingly, since the press forming is performed in the state where the mandrel 60 is inserted into the intermediate molded body 50, a deformation amount due to the press is regulated by the mandrel 60.

Specifically, in the case of the mandrel 60 having the circular cross-section, when the short width Db4 of the intermediate flat portion 52 reaches the outer diameter of the mandrel 60, the intermediate flat portion 52 is not deformed any more. Therefore, it is possible to easily form the flat straight-pipe portion 13 having the desired shape. Moreover, the diameter of the mandrel 60 is equal to or shorter than the short width Db2 of the flat flow-passage in the flat straight-pipe portion 13.

That is, in the case of performing the press forming, the gap remains formed in the direction of the long width Db1 of the flat straight-pipe portion 13. Even though the gap exists, since the intermediate flat portion 52 of the intermediate molded body 50 is previously molded, it is possible to form the desired flat straight-pipe portion 13. Further, it is possible to easily insert the mandrel 60 into the intermediate molded body 50 by forming the diameter of the mandrel 60 to be equal to or shorter than the short width Db2 of the flat flow-passage in the flat straight-pipe portion 13.

In addition, the resin hose 10 has the flat straight-pipe portion 13 which is continuous to the bent portion 12. Further, the bent portion 12 of the resin hose 10 includes at least a part of the intermediate flat portion 52. Moreover, the outer bent side and the inner bent side of the bent portion 12 become both sides in the direction of the short width of the intermediate flat portion 52. Therefore, when the bent portion 12 is formed by press forming, wrinkles are less likely to occur in the bent portion 12 by configuring such that at least a part of the bent portion 12 includes the previously molded intermediate flat portion 52 and both sides in the direction of the short width become the outer bent side and the inner bent side.

In addition, the resin hose 10 is provided with one-end round portion 11 including the minimum inner diameter portion at one end of the flat straight-pipe portion 13. the resin hose 10 is provided with the intermediate round portion 14 and the other-end round portion 16 including the minimum inner diameter portion at the other end of the flat straight-pipe portion. The minimum inner diameter portions of the round portions 11, 14, 16 are disposed at both ends of the flat straight-pipe portion 13. That is, the long width Db1 of the flat straight-pipe portion 13 is larger than the inner diameters Da and Dc of the minimum inner diameter portion of the round portions 11, 14, and 16. For this reason, in the resin hose 10 provided with the round portions 11, 14, and 16 having the minimum inner diameter at both ends of the flat straight-pipe portion 13, since the mandrel is formed into an undercut shape when the forming is performed only by the mandrel, it is difficult to perform the forming with the mandrel. However, even in the resin hose 10 having such a shape, it is possible to reliably perform the forming without depending on the shape of the mandrel 60 by applying the manufacturing method according to the first embodiment.

### Second Embodiment

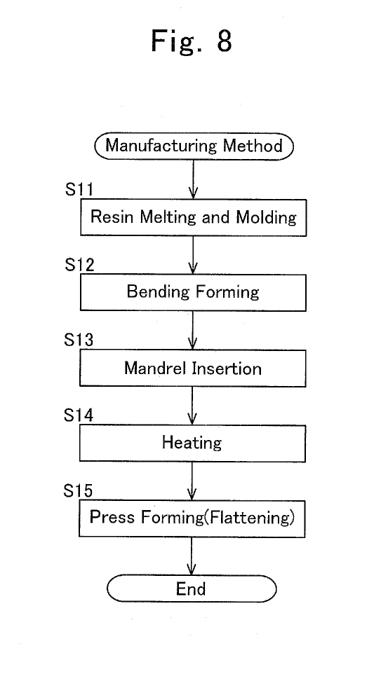

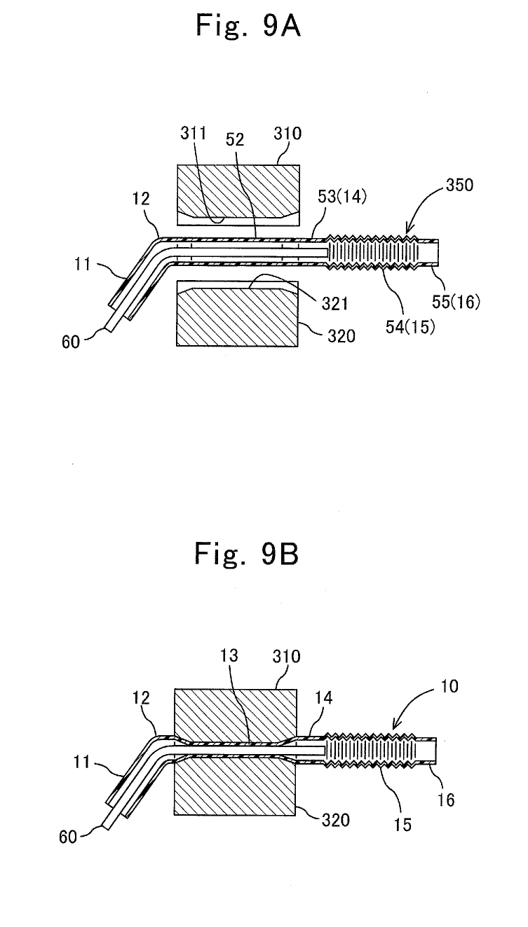

A method for manufacturing a resin hose 10 according to a second embodiment will be described with reference to FIGS. 8, 9A, and 9B. In the following description, the same elements as in the first embodiment will be denoted by the same reference numerals and the description thereof will not be presented.

As illustrated in FIG. 8, according to the method for manufacturing the resin hose 10 of the second embodiment, a worker manufactures a straight pipe-shaped intermediate molded body 50 using resin melting and molding (S11: resin melting and molding process). Subsequently, the worker forms a bent portion 12 (illustrated in FIG. 1) of the resin hose 10 by bending a part of a round portion 51 and a part of an intermediate flat portion 52 in the intermediate molded body 50 using, for example, a known bender (not illustrated). However, the intermediate molded body 50 is heated to be softened before forming of the bent portion 12. Hereinafter, a second intermediate molded body 350 (illustrated in FIG. 9A) corresponds the intermediate molded body 50 molded with the bent portion 12.

Subsequently, as illustrated in FIG. 9A, the workers inserts a mandrel 60, which has a circular cross-section shape and is formed by, for example, a flexible resin material or metal spring, into the second intermediate molded body 350 (S13). Subsequently, the workers form the flat straight-pipe portion 13 using press forming (S15: press forming process) after heating and softening the second intermediate molded body 350 (S14).

As illustrated in FIGS. 9A and 9B, metal molds 310 and 320 are used in the press forming process. Cavities formed in the metal molds 310 and 320 include flat forming portions 311 and 321 corresponding to the flat straight-pipe portion 13.

Here, the second intermediate molded body 350 is disposed between the metal molds 310 and 320 such that the metal molds 310 and 320 are located in the short width direction of the intermediate flat portion 52. If a portion of the second intermediate molded body 350 disposed between the metal molds 310 and 320 has a cylindrical shape, the phase of the second intermediate molded body 350 is not easily positioned with respect to the metal molds 310 and 320. However, since the intermediate flat portion 52 is previously molded in the second intermediate molded body 350 and the metal molds 310 and 320 are located in the direction of the short width of the intermediate flat portion 52, the second intermediate molded body 350 can be easily and stably disposed between the metal molds 310 and 320. Accordingly, it is possible to form the resin hose 10 having the desired shape.

Further, the example of applying the resin hose 10 to a filler hose of an automobile is described in the above embodiments, but the invention is not limited thereto and any resin hose through which fluid flows is applicable regardless of uses.

What is claimed is:

1. A resin hose comprising:
a round portion having a round flow-passage; and
a flat portion that includes a flat flow-passage and has a flow-passage cross-section area equal to or larger than a flow-passage cross-section area of a minimum inner diameter portion in the round portion, a short width of the flat flow-passage being smaller than an inner diameter of the minimum inner diameter portion and a long width of the flat flow-passage being larger than the inner diameter of the minimum inner diameter portion.

2. The resin hose according to claim 1, wherein the flat portion is manufactured using:
a resin melting and molding process of molding an intermediate flat portion of an intermediate molded body, the intermediate flat portion having a flow-passage cross-section area larger than the flow-passage cross-section area of the flat portion, by introducing a molten resin into a metal mold having a flat-shaped inner peripheral surface and then solidifying the molten resin; and
a press forming process of forming the flat portion by press forming the intermediate flat portion of the intermediate molded body to further reduce a short width of the intermediate flat portion in the intermediate molded body.

3. The resin hose according to claim 2, wherein the short width of the flat flow-passage of the intermediate flat portion in the intermediate molded body is equal to or larger than the inner diameter of the round portion, and
the long width of the flat flow-passage of the intermediate flat portion in the intermediate molded body is larger than the inner diameter of the round portion.

4. The resin hose according to claim 2, wherein the flat portion is formed by press forming the intermediate flat portion in a state where a mandrel having a diameter equal to or smaller than the short width of the flat flow-passage in the flat portion is inserted into the intermediate molded body, in the press forming process.

5. The resin hose according to claim 4, wherein the resin hose comprises a straight pipe portion and a bent portion formed by at least a part of the intermediate flat portion,
the intermediate molded body is molded into a straight pipe shape, and
the flat portion is formed in the resin hose and the bent portion is also formed such that both sides in the direction of the short width of the intermediate flat portion become an outer bent side and an inner bent side of the bent portion, by press forming the intermediate molded body having the straight pipe shape, in the press forming process.

6. The resin hose according to claim 1, wherein the minimum inner diameter portion of the round portion is disposed at both ends of the flat portion.

7. A method for manufacturing a resin hose having a flat portion, the method comprising:
a resin melting and molding process of molding an intermediate flat portion of an intermediate molded body by introducing a molten resin into a metal mold having a flat-shaped inner peripheral surface and then solidifying the molten resin; and
a press forming process of forming the flat portion having a flow-passage cross-section area smaller than a flow-passage cross-section area of the intermediate flat portion of the intermediate molded body by press forming the intermediate flat portion of the intermediate molded body to further reduce a short width of the intermediate flat portion in the intermediate molded body.
